(19) United States
(12) Patent Application Publication
(10) Pub. No.: US 2016/0136667 A1
(43) Pub. Date: May 19, 2016

(54) PUMP ASSEMBLY FOR CONNECTION TO A CONTAINER

(71) Applicant: COLGATE-PALMOLIVE COMPANY, New York, NY (US)

(72) Inventors: Paul Donald Carse, Milford, NJ (US); Matthew Lee Kolb, Upper Black Eddy, PA (US)

(21) Appl. No.: 14/901,040

(22) PCT Filed: Jun. 26, 2013
(86) PCT No.: PCT/US2013/047740

§ 371 Date: Dec. 27, 2015

(51) Int. Cl. B05B 11/00

(52) U.S. Cl. CPC B05B 11/3035; B05B 11/3047; B05B 11/3042

(57) ABSTRACT

Disclosed is a pump assembly (100) for connection to a container (200) and comprising: a base (10) for connection to the container (200) and defining a first flow path; a dispenser (20) defining a second How path and an outlet in fluid communication with the second flow path; a deformable vessel (30) defining a cavity of variable volume fluidly connecting the first flow path to the second flow path; and a resilient device unitary (40, 50, 60) with one of the base (10) and the dispenser (20) and discrete from the vessel (30); wherein the dispenser (20) is movable relative to the base (10) to deform the vessel (30) thereby to vary the volume of the cavity, and the resilient device (40, 50, 60) is configured to urge the dispenser (20) away from the base (10) thereby to increase the volume of the cavity. Also disclosed is a dispenser apparatus comprising such a pump assembly, and a method of manufacturing such a pump assembly.

### BACKGROUND

The present invention relates to a pump assembly for connection to a container, to a dispenser apparatus comprising such a pump assembly, and to a method of manufacturing such a pump assembly.

It is known to provide, to containers comprising chambers storing a flowable substance, a pump assembly for pumping the flowable substance from the chamber to an exterior of the container, in order to dispense the flowable substance. in some known containers, the pump assembly comprises two relatively movable parts for pumping the flowable substance and a metal coil spring for biasing the two parts apart. The use of a metal coil spring increases the cost and complexity of the pump assembly.

There is a need for an improved pump assembly that eliminates the need for a metal coil spring for biasing apart two relatively movable parts of the pump assembly.

### BRIEF SUMMARY

An embodiment of the present invention provides a pump assembly for connection to a container, the assembly comprising: a base for connection to the container and defining a first flow path; a dispenser defining a second flow path and an outlet in fluid communication with the second flow path; a deformable vessel defining a cavity of variable volume fluidly connecting the first flow path to the second flow path; and a resilient device unitary with one of the base and the dispenser and discrete from the vessel; wherein the dispenser is movable relative to the base to deform the vessel thereby to vary the volume of the cavity, and the resilient device is configured to urge the dispenser away from the base thereby to increase the volume of the cavity.

Optionally, the resilient device is unitary with the base.

Optionally, the resilient device is discrete from the other of the base and the dispenser.

Optionally, the resilient device is in the form of an arm having a first proximal end connected to the one of the base and the dispenser and a second distal free end contacting the other of the base and the dispenser.

Optionally, the resilient device has the shape of a full or partial helix.

Optionally, the resilient device is disposed outside of the vessel.

Optionally, the resilient device is movable relative to the vessel.

Optionally, the pump assembly comprises a plurality of the resilient devices,

Optionally, the vessel is non-resilient. Alternatively, the vessel is resilient.

Optionally, the vessel is deformable according to a predetermined pattern of collapse.

Optionally, the vessel comprises a bellows.

Optionally, the pump assembly comprises at least one stop delimiting a range of relative movement of the dispenser and the base.

Optionally, the pump assembly comprises a first valve configured to permit fluid flow from the first flow path to the cavity and to prevent or hinder fluid flow from the cavity to the first flow path.

Optionally, the first valve is unitary with the vessel.

Optionally, the first valve is at least partially disposed within material forming the vessel.

Optionally, the first valve is formed from an elastomeric material.

Optionally, the pump assembly comprises a second valve configured to permit fluid flow from the cavity to the second flow path and to prevent or hinder fluid flow from the second flow path to the cavity.

Optionally, the second valve is unitary with the vessel.

Optionally, the second valve is at least partially disposed within material forming the vessel.

Optionally, the second valve is formed from an elastomeric material.

Optionally, at least a portion of the base is disposed within the dispenser.

Optionally, at least a portion of the vessel is disposed within the dispenser.

Optionally, at least a portion of the vessel is disposed within the base.

Optionally, the base comprises a screw thread for connection to a screw thread of the container.

Optionally, the pump assembly comprises a dip tube connected to the base and defining a lumen in fluid communication with the first flow path.

Another embodiment of the present invention provides a dispenser apparatus, comprising: a container defining a chamber for storing a flowable substance; and a pump assembly according to the first aspect of the present invention, wherein the base is connected to the container with the first flow path in fluid communication with the chamber.

Optionally, the dispenser apparatus comprises the flowable substance in the chamber.

A further embodiment of the present invention provides a method of manufacturing a pump assembly, comprising: providing a base for connection to a container and defining a first flow path, a dispenser defining a second flow path and an outlet in fluid communication with the second flow path, and a resilient device unitary with one of the base and the dispenser; and connecting the dispenser to the base via a deformable vessel discrete from the resilient device and defining a cavity of variable volume with the cavity fluidly connecting the first flow path to the second flow path, the dispenser movable relative to the base to deform the vessel thereby to vary the volume of the cavity, and the resilient device urging the dispenser away from the base thereby to increase the volume of the cavity.

Optionally, the resilient device is unitary with the base.

Optionally, the resilient device is discrete from the other of the base and the dispenser.

Optionally, the providing comprises molding as one piece the resilient device and the one of the base and the dispenser.

Optionally, the connecting comprises disposing the resilient device outside of the vessel.

Optionally, the resilient device is movable relative to the vessel when the dispenser is connected to the base.

Optionally, the providing comprises providing a plurality of the resilient devices.

Optionally, the vessel is non-resilient. Alternatively, the vessel is resilient.

Optionally, the vessel is deformable according to a predetermined pattern of collapse.

Optionally, the vessel comprises a bellows.

Optionally, the method comprises providing a first valve configured to permit fluid flow from the first flow path to the cavity and to prevent or hinder fluid flow from the cavity to the first flow path when the dispenser is connected to the base via the deformable vessel.

Optionally, the method comprises forming as one piece the first valve and the vessel.

Optionally, the method comprises molding the vessel over the first valve so that the first valve becomes at least partially disposed within material forming the vessel,

Optionally, the method comprises providing a second valve configured to permit fluid flow from the cavity to the second flow path and to prevent or hinder fluid flow from the second flow path to the cavity when the dispenser is connected to the base via the deformable vessel.

Optionally, the method comprises forming as one piece the second valve and the vessel.

Optionally, the method comprises molding the vessel over the second valve so that the second valve becomes at least partially disposed within material forming the vessel.

Optionally, the base comprises a screw thread for engagement with a screw thread of a container.

Optionally, the method comprises connecting to the base a dip tube defining a lumen so that the lumen is in fluid communication with the first flow path.

Further areas of applicability of the present invention will become apparent from the detailed description provided hereinafter. it should be understood that the detailed description and specific examples, while indicating the preferred. embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded view of components of a pump assembly according to an embodiment of the present invention;

FIG. 2 is a perspective view of the components of FIG. 1 fully assembled to form the pump assembly, the pump assembly being unconnected from a container; and

FIG. 3 is a perspective view of the pump assembly and the container of FIG. 2 connected to each other to form a dispenser apparatus according to an embodiment of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. in addition, all references cited herein are hereby incorporated by referenced in their entireties. in the event of a conflict in a definition in the present disclosure and that of a cited reference, the present disclosure controls,

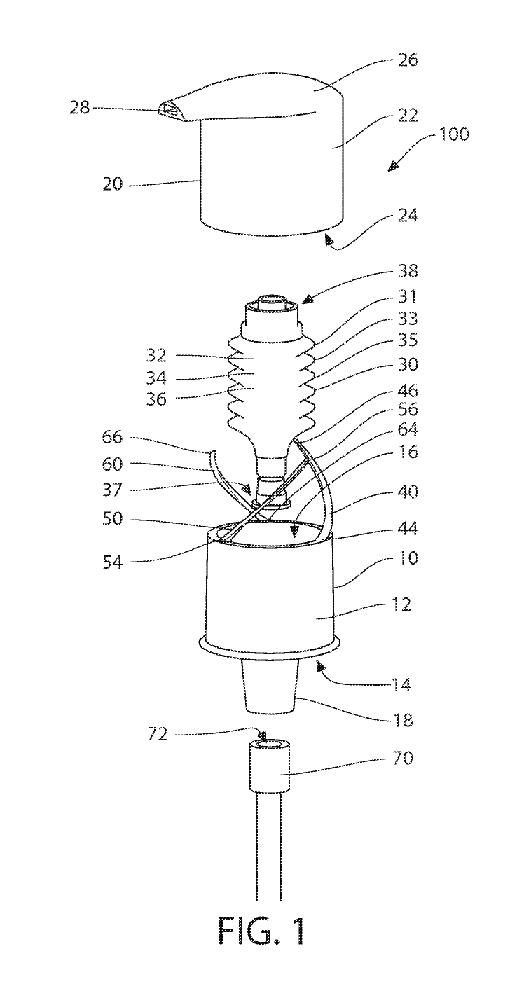

With reference to FIG. 1, there is shown an exploded view of a pump assembly 100 according to a first embodiment of the present invention, in short, the pump assembly 100 comprises a base 10, a dispenser 20, a deformable vessel 30 and a plurality of resilient devices 40, 50, 60. Each of the resilient devices 40, 50, 60 is unitary with the base 10 and discrete from each of the dispenser 20 and the vessel 30.

By “unitary”, it is meant that the resilient devices 40, 50, 60 are integrally formed with the base 10. That is, the base 10 and the resilient devices 40, 50, 60 are one piece. By “discrete”, it is meant that the resilient devices 40, 50, 60, the dispenser 20 and the vessel 30 are separate, distinct components of the pump assembly 100 and are not unitary, or integrally formed. Nevertheless, the resilient devices 40, 50, 60 are in contact with the dispenser 20, as will be described in more detail below.

The base 10 comprises an annular body 12 having a first open end 14 for receiving a neck 202 of a container 200 and a second open end 16 for receiving a portion of the vessel 30. Extending from the first open end 14, and within the annular body 12, there is provided a female screw thread (not shown) for engagement with a male screw thread 204 on the neck 202 of the container 200 to connect the base 10, and the rest of the pump assembly 100, to the container 200. In a variation to the illustrated embodiment, the annular body 12 may comprise a male screw thread for engagement with a female screw thread of a container 200 to connect the base 10, and the rest of the pump assembly 100, to the container 200. In further variations to the illustrated embodiment, the base 10 may be connectable to a container by some other mechanism, such as a snap-fit connection, a push-fit connection, adhesion or welding, as will be known to the skilled person.

The base 10 further comprises an annular first seat (not shown) extending radially inwardly from the annular body 12, and a tubular member 18 extending axially from the first seat and through the first open end 14 of the annular body 12. When the annular body 12 of the base 10 is connected to the container 200, a distal end of the tubular member 18 is disposed within the neck 202 of the container 200, The tubular member 18 of the base 10 defines a first flow path from the distal end of the tubular member 18 to the first seat. The base 10 is a unitary component comprising all of the annular body 12, the first seat and the tubular member 18. In a variation to the illustrated embodiment, a plurality of partially-annular first seats may be substituted for the single annular first seat.

Each of the resilient devices 40, 50, 60 is in the form of an arm having a first proximal end 44, 54, 64 connected to a rim of the annular body 12 defining the second open end 16, and a second distal free end 46, 56, 66, which contacts the dispenser 20 when the pump assembly 100 is fully assembled, as will be described below. Each of the arms 40, 50, 60 has the shape of a partial helix. In a variation to this embodiment, one or more of the resilient devices may have the shape of a full helix. In the illustrated embodiment, the first proximal ends 44, 54, 64 of the resilient devices 40, 50, 60 are equally circumferentially spaced around the second open end 16 of the annular body 12. While in the illustrated embodiment there are provided three resilient devices 40, 50, 60, in variations to the illustrated embodiment there may be provided only one resilient device, or a plurality of resilient devices, e.g. only two resilient devices or more than three resilient devices.

The pump assembly 100 further comprises a dip tube 70 defining a lumen 72. When the pump assembly 100 is fully assembled, the dip tube 70 is connected to the distal end of the tabular member 18 of the base 10, so that the lumen 72 is in fluid communication with the first flow path of the base 10.

The dispenser 20 comprises an annular body portion 22 having a first open end 24 fix receiving a portion of the vessel 30, at least a portion of the annular body 12 of the base 10, and the resilient devices 40, 50, 60. Accordingly, when the pump assembly 100 is fully assembled, at least a portion of the base 10 is disposed within the dispenser 20. The dispenser 20 further comprises an annular second seat (not shown) extending radially inwardly from the annular body portion 22. The dispenser 20 also comprises an end portion 26 defining an outlet 28 extending radially outwardly of the dispenser 20. Together the annular body portion 22 and the end portion 26 of the dispenser 20 define a second flow path with which the outlet 28 is in fluid communication. The dispenser 20 is a unitary component comprising all of the annular body portion 22, the second seat and the end portion 26. In a variation to the illustrated embodiment, a plurality of partially-annular second seats may be substituted for the single annular second seat.

The deformable vessel 30 comprises a bellows that is deformable according to a predetermined pattern of collapse. In particular, the vessel 30 comprises an annular wall comprising relatively larger diameter sections 31, 33, 35 interspaced with relatively smaller diameter sections 32, 34, 36, The relatively larger and smaller diameter sections are movable towards and away from each other in an axial direction of the annular wall, so that the vessel 30 is collapsible and expandable in the axial direction of the annular wall. The vessel 30 defines an internal cavity, which fluidly connects the first flow path of the body 10 to the second flow path of the dispenser 20 when the pump assembly 100 is fully assembled. Deformation of the vessel 30 causes a volume of the cavity to be varied. Accordingly, the cavity is of variable volume. More specifically, when the vessel 30 is collapsed, the volume of the cavity is reduced, whereas when the vessel 30 is expanded, the volume of the cavity is increased.

The vessel 30 has a first end 37 and a second end 38, the first and second ends 37, 38 being disposed at opposite ends of the cavity defined by the vessel 30. The pump assembly 100 comprises a first one-way valve (not shown) at the first end 37 of the vessel 30, which first valve is configured to permit fluid flow into the cavity and to prevent or hinder fluid flow from the cavity. The pump assembly 100 also comprises a second one-way valve (not shown) at the second end 38 of the vessel 30, which second valve is configured to permit fluid flow from the cavity and to prevent or hinder fluid flow into the cavity.

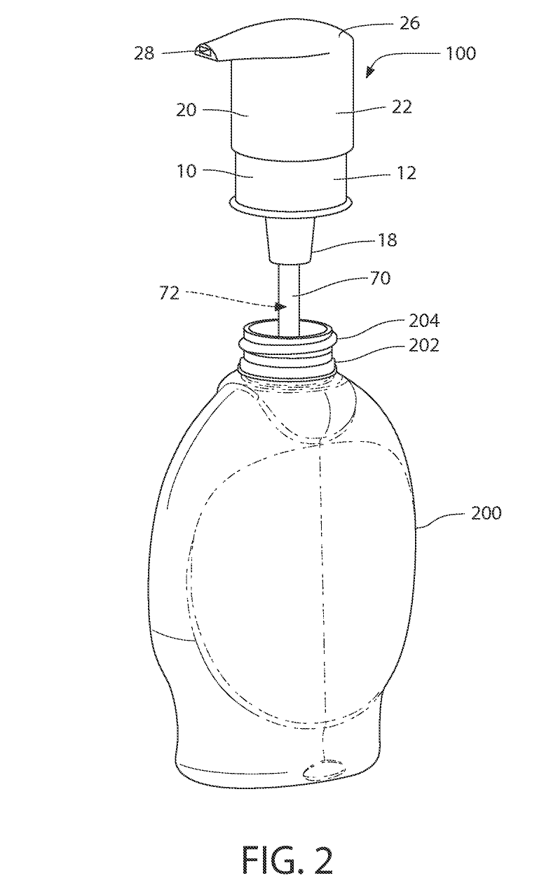

Manufacture of the illustrated pump assembly 100 and its components will now be described, with reference to FIGS. 1 and 2.

The base 10 is provided by being molded (such as injection molded or injection blow molded or other appropriate molding processes) from a material, preferably a plastic material such as polypropylene. In order to provide that each of the resilient devices 40, 50, 60 is unitary with the base 10, the resilient devices 40, 50, 60 and the base 10 are molded simultaneously as one piece from a. common volume of the material. In a variation to this process, the base 10 and the resilient devices 40, 50, 60 may be machined from a single piece of material. In either case, the base 10 and the resilient devices 40, 50, 60 are together formed as a unitary piece. The material from which the resilient devices 40, 50, 60 are made, and thus in this embodiment from which the base 10 is made, must have some resilience, in order to ensure that resilient devices 40, 50, 60 are indeed resilient.

The dispenser 20 is provided by being molded (such as injection molded or injection blow molded or other appropriate molding processes), or machined, from a material, preferably a plastic material such as polypropylene. The dip tube 70 may be formed by any known method, such as by molding, or extruding and cooling, a material, such as a plastic material.

The vessel 30 is provided preferably by being injection blow molded from an elastomeric material, such as a thermoplastic elastomer. Each of the first and second valves is pre-formed, e.g. from an elastomeric material such as a thermoplastic elastomer, and is overmolded by the material of the vessel 30 during manufacture of the vessel 30, so that each of the first and second valves is at least partially disposed within the material forming the vessel 30. In variations to this embodiment, the first and second valves may be formed from material other than an elastomeric material and/or may be attached to a pre-formed vessel 30 in alternative ways, For example, one or both of the first and second valves may instead be inserted into, adhered to, or otherwise fixed to, the respective first and second ends 37, 38 of the vessel 30 after manufacture of the vessel 30. In other embodiments, one or both of the first and second valves may be unitary with the vessel 30; that is, one or both of the first and second valves may be integrally, formed with the vessel 30 at the same time as the vessel 30 is formed. Accordingly, in some embodiments the first and second valves are made from the same material as the vessel 30, while in other embodiments they are made from a different material to the vessel 30.

In assembling the pump assembly 100, the dispenser 20 is connected to the base 10 via the deformable vessel 30, More specifically, at least a portion of the vessel 30 is disposed within the annular body 12 of the base, with the first end 37 of the vessel 30 (with the first valve integral therewith or connected thereto) in contact with the first seat of the base 10, so that the cavity of the vessel 30 becomes fluidly connected to the first flow path of the base 10 via the first valve, and so that the resilient devices 40, 50, 60 and the annular body 12 are disposed around and outside of the at least a portion of the vessel 30. The first end 37 of the vessel 30 is fixed to the base 10 (optionally to the first seat of the base 10), such as by a snap-tit connection, a push-fit connection, adhesion or welding.

At least a portion of the vessel 30 is disposed within the annular body portion 22 of the dispenser 20, with the second end 38 of the vessel 30 (with the second valve integral therewith or connected thereto) in contact with the second seat of the dispenser 20, so that the cavity of the vessel 30 becomes fluidly connected to the second flow path of the dispenser 20 via the second valve, and so that at least a portion of the annular body 12 of the base 10 and the resilient devices 40, 50, 60 are disposed within the annular body portion 22 of the dispenser 20. During this assembly step, the distal free ends 46, 56, 66 of the resilient devices 40, 50, 60 are brought into contact with the second seat of the dispenser 20, and the resilient devices 40, 50, 60 may then be partially compressed between the base 10 and the dispenser 20, more specifically between the first seat of the base 10 and the second seat of the dispenser 20. Accordingly, the resilient devices 40, 50, 60 act to urge the dispenser 20 away from the base 10, thereby to bias the vessel 30 towards its expanded state to increase the volume of the cavity of the vessel 30. The second end 38 of the vessel 30 is fixed to the dispenser (further optionally to the second seat of the dispenser 20), such as by a snap-fit connection, a push-fit connection, adhesion or welding. 00711 The dip tube 70 is then connected to the distal end of the tubular member 18 of the base 10, so that the lumen 72 is brought into fluid communication with the first flow path of the base 10. In the illustrated embodiment, this connection is effected through an end of the dip tube 70 being push-fit into the distal end of the tubular member 18. However, in variations to the illustrated embodiment, the dip tube 70 may be connected to the distal end of the tubular member 18 by some other mechanism, such as a snap-fit connection, a mating-threads connection, adhesion or welding, as will be known to the skilled person.

With the pump assembly 100 assembled as discussed above, the dispenser 20 is movable relative to the base 10 to deform the vessel 30 thereby to vary the volume of the cavity of the vessel 30. More specifically, application of a force to the dispenser 20 with a component in the direction of the base 10 causes the dispenser 20 to move towards the base 10, against the resilience of the resilient devices 40, 50, 60, to collapse the vessel 30 thereby to reduce the volume of the cavity of the vessel 30. This movement causes movement of the resilient devices 40, 50, 60 relative to the vessel 30 and compression of the resilient devices 40, 50, 60 between the base 10 and the dispenser 20. When the force is reduced or removed, the resilience of the resilient devices 40, 50, 60 effects extension of the resilient devices 40, 50, 60 to urge the dispenser 20 away from the base 10, thereby to assist in the expansion of the vessel 30 and increase the volume of the cavity of the vessel 30.

The pump assembly 100 comprises a pair of stops that act to delimit a range of relative movement of the dispenser 20 and the base 10. In the illustrated embodiment, the vessel 30 acts as one of these stops, while cooperation of the dispenser 20 and the resilient devices 40, 50, 60 acts as the other of the stops. The first and second ends 37, 38 of the vessel 30 are respectively fixed to the base 10 and the dispenser 20, and the resilient devices 40, 50, 60 are configured to urge the dispenser 20 away from the base 10 to cause the vessel 30 to reach its maximum expansion. When the vessel 30 reaches its maximum expansion, the connection of the dispenser 20 to the base 10 via the vessel 30 prevents the dispenser 20 from moving further from the base 10. On the other hand, when the dispenser 20 is moved towards the base 10, after the resilient devices 40, 50, 60 have been fully compressed, the resilient devices 40, 50, 60 interfere with the dispenser 20 to prevent further movement of the dispenser 20 towards the base 10.

In a variation to the illustrated embodiment, one or both of the first and second ends 37, 38 of the vessel 30 may not be fixed to the base 10 and the dispenser 20, respectively. In these variations, preferably the vessel 30 is resilient and the resilience of the vessel 30 biases the vessel 30 towards its expanded state, so as to ensure that the first and second ends 37, 38 of the vessel 30 remain in contact with the first and second seats of the base 10 and the dispenser 20, respectively. Moreover, in these variations, there may be provided one or more first elements extending radially outwardly from the annular body 12 of the base 10, and one or more second elements extending radially inwardly from the annular body portion 22 of the dispenser 20, which first and second elements act as stops that cooperate to delimit the range of possible relative movement of the dispenser 20 and the base 10.

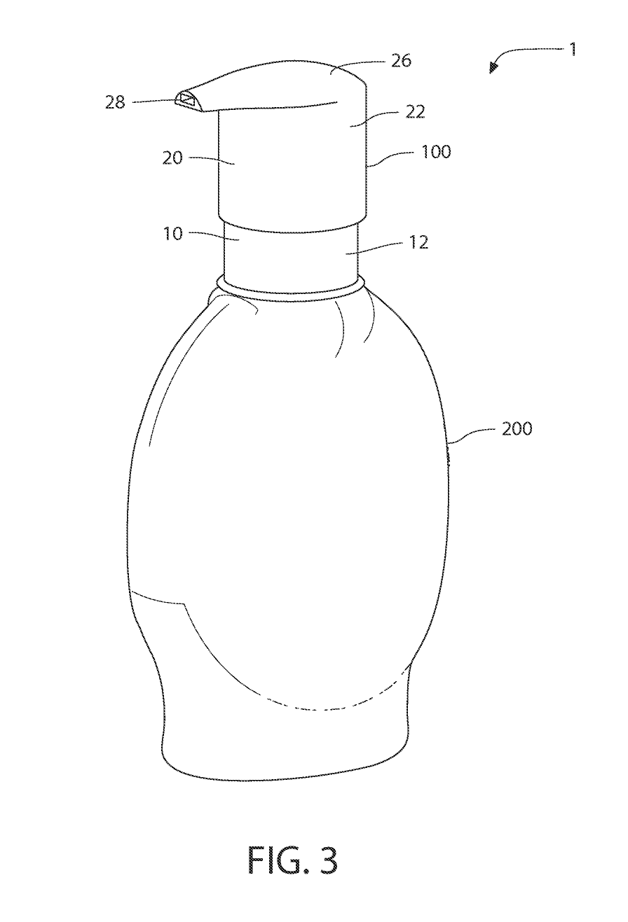

With reference to FIGS. 2 and 3, the pump assembly 100 is then connected to the container 200, which container 200 defines a chamber storing a flowable substance, to form a dispenser apparatus 1. More specifically, the distal end of the tubular member 18 is disposed within the neck 202 of the container 200 so that the dip tube 70 extends into the chamber of the container 200, and the female screw thread of the base 10 is engaged with the male screw thread 204 on the neck 202 of the container 200 to connect the base 10, and the rest of the pump assembly 100, to the container 200. Accordingly, the first flow path of the base 10 is brought into fluid communication with the chamber of the container 200 via the lumen 72 of the dip tube 70.

The pump assembly 100 is operable to pump the flowable substance from the chamber of the container 200 and to dispense the flowable substance from the dispenser apparatus 1 through the outlet 28. Specifically, when the dispenser apparatus 1 is in the state shown in FIG. 3, with the dispenser 20 spaced from the base 10 and the vessel 30 expanded, application of a force to the dispenser 20 with a component in the direction of the base 10 causes the dispenser 20 to move towards the base 10, against the resilience of the resilient devices 40, 50, 60, to collapse the vessel 30 thereby to reduce the volume of the cavity of the vessel 30. During this movement, such collapse of the vessel 30 causes an increase in pressure in the cavity of the vessel 30, which forces the first one-way valve to close to prevent any fluid (such as air and/or the flowable substance) in the cavity of the vessel 30 from passing into the first flow path. However, the increase in pressure forces the second one-way valve and causes any fluid (such as air and/or the flowable substance) in the cavity of the vessel 30 to pass into the second flow path. Subsequent reduction or removal of the force allows the resilient devices 40, 50, 60 to urge the dispenser 20 away from the base 10, thereby to expand the vessel 30 and increase the volume of the cavity of the vessel 30. During this movement, such expansion of the vessel 30 causes a reduction in pressure in the cavity of the vessel 30, which forces the second one-way valve to close to prevent any fluid (such as air and/or the flowable substance) in the cavity of the vessel 30 from passing into the second flow path. However, the reduction in pressure means that the pressure in the chamber of the container 200 becomes greater than the pressure in the cavity of the vessel 30. Accordingly, the first one-way valve is forced open and a volume of the flowable substance in the lumen 72 of the dip tube, and optionally in the chamber of the container 200, is pushed or drawn into the cavity of the vessel 30 via the first flow path and the first valve. Re-application of the force causes repetition of these motions, so that there is net movement of the flowable substance from the chamber of the container 200 to the outlet 28, via the lumen 72 of the dip tube 70, the first flow path, the cavity of the vessel 30, and the second flow path, in that order.

In the illustrated embodiment, the resilient devices 40, 50, 60 are unitary with the base 10 and discrete from the dispenser 20 and the vessel 30. In a variation to the illustrated embodiment, the resilient devices 40, 50, 60 may be unitary with the dispenser 20 and discrete from the base 10 and the vessel 30. In a further variation to the illustrated embodiment, the resilient devices 40, 50, 60 may be unitary with both the dispenser 20 and the base 10 and discrete from the vessel 30. In any event, since the pump assembly comprises one or more resilient devices that are unitary with one or other or both of the base and the dispenser, and the one or more resilient devices are configured to urge the dispenser away from the base thereby to increase the volume of the cavity, the need for an additional spring, such as a metal coil spring, for biasing apart the base and the dispenser is eliminated.

Moreover, since the one or more resilient devices are discrete from the vessel, the vessel is simple to manufacture, as compared to a comparative system in which the one or more resilient devices are unitary with, or otherwise incorporated into, the vessel.

In some embodiments, the deformable vessel 30 is made of resilient materials, so the deformable vessel 30 is resilient and tends to expand rather than collapse. However, the resilient devices 40, 50, 60 may assist the deformable vessel 30 in urging the dispenser 20 away from the base 10 thereby to increase the volume of the cavity. However, in other embodiments, the deformable vessel 30 may be non-resilient, or may be semi-resilient such that the resilient devices 40, 50, 60 may be used to assist movement of the dispenser 20 away from the base 10 thereby to increase the volume of the cavity.

1. A pump assembly for connection to a container, the pump assembly comprising:
a base for connection to the container and defining a first flow path;
a dispenser defining a second flow path and an outlet in fluid communication with the second flow path;
a deformable vessel defining a cavity of variable volume fluidly connecting the first flow path to the second flow path; and
a resilient device unitary with one of the base and the dispenser and discrete from the vessel;
wherein the dispenser is movable relative to the base to deform the vessel thereby to vary the volume of the cavity, and the resilient device is configured to urge the dispenser away from the base thereby to increase the volume of the cavity.

2. A pump assembly according to claim 1 wherein the resilient device is unitary with the base.

3. A pump assembly according to claim 1 wherein the resilient device is discrete from the other of the base and the dispenser.

4. A pump assembly according to claim 1 wherein the resilient device is in the form of an arm having a first proximal end connected to the one of the base and the dispenser and a second distal free end contacting the other of the base and the dispenser.

5. A pump assembly according to claim 1 wherein the resilient device has the shape of a full or partial helix.

6. A pump assembly according to claim 1 wherein the resilient device is disposed outside of the vessel.

7. A pump assembly according to claim 1 wherein the resilient device is movable relative to the vessel.

8. A pump assembly according to claim 1 comprising a plurality of the resilient devices.

9. A pump assembly according to claim 1 wherein the vessel is non-resilient.

10. A pump assembly according to claim 1 wherein the vessel is deformable according to a predetermined pattern of collapse, and/or wherein the vessel comprises a bellows.

11. A pump assembly according to claim 1 comprising at least one stop delimiting a range of relative movement of the dispenser and the base.

12. A pump assembly according to claim 1 comprising a first valve configured to permit fluid flow from the first flow path to the cavity and to prevent or hinder fluid flow from the cavity to the first flow path.

13. A pump assembly according to claim 12 wherein the first valve is unitary with the vessel, or wherein the first valve is at least partially disposed within material forming the vessel.

14. A pump assembly according to claim 12 wherein the first valve is formed from an elastomeric material.

15. A pump assembly according to claim 1 comprising a second valve configured to permit fluid flow from the cavity to the second flow path and to prevent or hinder fluid flow from the second flow path to the cavity.

16. A pump assembly according to claim 15 wherein the second valve is unitary with the vessel, or wherein the second valve is at least partially disposed within material forming the vessel.

17. A pump assembly according to claim 15 wherein the second valve is formed from an elastomeric material.

18. A pump assembly according to claim 1 wherein at least a portion of the base is disposed within the dispenser.

19. A pump assembly according to claim 1 wherein at least a portion of the vessel is disposed within the dispenser, and/or wherein at least a portion of the vessel is disposed within the base.

20. A pump assembly according to claim 1 wherein the base comprises a screw thread for connection to a screw thread of the container.

21. A pump assembly according to claim 1 comprising a dip tube connected to the base and defining a lumen in fluid communication with the first flow path.

22. A dispenser apparatus, comprising:
a container defining a chamber for storing a flowable substance; and
a pump assembly according to any one of claims 1 to 21, wherein the base is connected to the container with the first flow path in fluid communication with the chamber.

23. A dispenser apparatus according to claim 22, comprising the flowable substance in the chamber.

24. A method of manufacturing a pump assembly, comprising:
providing a base for connection to a container and defining a first flow path, a dispenser defining a second flow path and an outlet in fluid communication with the second flow path, and a resilient device unitary with one of the base and the dispenser; and
connecting the dispenser to the base via a deformable vessel discrete from the resilient device and defining a cavity of variable volume with the cavity fluidly connecting the first flow path to the second flow path, the dispenser movable relative to the base to deform the vessel thereby to vary the volume of the cavity, and the resilient device urging the dispenser away from the base thereby to increase the volume of the cavity.

25. A method according to claim 24 wherein the resilient device is unitary with the base.

26. A method according to claim 24 wherein the resilient device is discrete from the other of the base and the dispenser.

27. A method according to claim 24 wherein the providing comprises molding as one piece the resilient device and the one of the base and the dispenser.

28. A method according to claim 24 wherein the connecting comprises disposing the resilient device outside of the vessel.

29. A method according to claim 24 wherein the resilient device is movable relative to the vessel when the dispenser is connected to the base.

30. A method according to claim 24 wherein the providing comprises providing a plurality of the resilient devices.

31. A method according to claim 24 wherein the vessel is non-resilient.

32. A method according to claim 24 wherein the vessel comprises a bellows.

33. A method according to claim 24 comprising providing a first valve configured to permit fluid flow from the first flow path to the cavity and to prevent or hinder fluid flow from the cavity to the first flow path when the dispenser is connected to the base via the deformable vessel.

34. A method according to claim 33 comprising forming as one piece the first valve and the vessel, or comprising molding the vessel over the first valve so that the first valve becomes at least partially disposed within material forming the vessel.

35. A method according to claim 24 comprising providing a second valve configured to permit fluid flow from the cavity to the second flow path and to prevent or hinder fluid flow from the second flow path to the cavity when the dispenser is connected to the base via the deformable vessel.

36. A method according to claim 35 comprising forming as one piece the second valve and the vessel, or comprising molding the vessel over the second valve so that the second valve becomes at least partially disposed within material forming the vessel.

37. A method according to claim 24 wherein the base comprises a screw thread for engagement with a screw thread of a container.

38. A method according to claim 24 comprising connecting to the base a dip tube defining a lumen so that the lumen is in fluid communication with the first flow path.
